(19) United States
(12) Patent Application Publication
(10) Pub. No.: US 2023/0131027 A1
(43) Pub. Date: Apr. 27, 2023

(54) MANAGING VIRTUAL BREAK SESSIONS

(71) Applicant: Dell Products L.P., Round Rock, TX (US)

(72) Inventors: Vaibhav Soni, Austin, TX (US); Tyler Ryan Cox, Austin, TX (US); Shipra Behera, Seattle, WA (US); Jake Mitchell Leland, Round Rock, TX (US)

(21) Appl. No.: 17/451,890

(22) Filed: Oct. 22, 2021

(51) Int. Cl. G06Q 10/10

(52) U.S. Cl. CPC G06Q 10/103

(57) ABSTRACT

Managing virtual break sessions, including: identifying user preferences associated with virtual break sessions; generating a weight for the user preferences; generating, based on the weights for the user preferences, a score for each virtual break session of potential virtual break sessions; comparing the score of each virtual break session of the potential virtual break sessions to a threshold score; determining, based on the comparing, that the score for a particular virtual break session of the potential virtual break sessions is greater than the threshold score, and in response, providing a notification to a display device indicating the particular virtual break session proximate to a time associated with the particular virtual break session; obtaining, during the particular virtual break session, user engagement signals associated with the particular virtual break session; and updating, based on the user engagement signals, the weight for each of the user preferences.

### BACKGROUND

### Field of the Disclosure

The disclosure relates generally to an information handling system, and in particular, managing virtual break sessions at the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Office collaboration in remote and hybrid work environments is an evolving problem space that has drawn large scale industry interest and investment.

### SUMMARY

Innovative aspects of the subject matter described in this specification may be embodied in a method of managing virtual break sessions for a user of an information handling system, the including: identifying a plurality of user preferences associated with virtual break sessions, including collaboration preferences, topic preferences, and time preferences; generating a weight for one or more of the user preferences; generating, based on the weights for the user preferences, a score for each virtual break session of a plurality of potential virtual break sessions; comparing the score of each virtual break session of the plurality of potential virtual break sessions to a threshold score; determining, based on the comparing, that the score for a particular virtual break session of the plurality of potential virtual break sessions is greater than the threshold score; in response to determining that the score for the particular virtual break session of the plurality of potential virtual break sessions is greater than the threshold score, providing a notification to a display device of the information handling system indicating the particular virtual break session proximate to a time associated with the particular virtual break session; obtaining, during the particular virtual break session, user engagement signals associated with the particular virtual break session; and updating, based on the user engagement signals, the weight for each of the user preferences.

Other embodiments of these aspects include corresponding systems, apparatus, and computer programs, configured to perform the actions of the methods, encoded on computer storage devices.

These and other embodiments may each optionally include one or more of the following features. For instance, after updating the weight for each of the user preferences: generating, based on the updated weights for each of the user preferences, an updated score for each virtual break session of the plurality of potential virtual break sessions; comparing the updated score of each virtual break session of the plurality of potential virtual break sessions to the threshold score; determining, based on the comparing, that the updated score for a further virtual break session of the plurality of potential virtual break sessions is greater than the threshold score; in response to determining that the updated score for the further virtual break session of the plurality of potential virtual break sessions is greater than the threshold score, providing a further notification to the display device of the information handling system indicating the further virtual break session proximate to a further time associated with the further virtual break session; obtaining, during the further virtual break session, further user engagement signals associated with the further virtual break session; and updating, based on the further user engagement signals, the updated weight for each of the user preferences. Obtaining the user engagement signals includes obtaining video-based user telemetry data, including performing facial analysis of the user during the particular virtual break session. Obtaining the user engagement signals includes obtaining audio-based user telemetry data, including performing audio analysis of the user during the particular virtual break session. Obtaining the user engagement signals includes obtaining system based telemetry data, including performing system interaction analysis of the user during the particular virtual break session. Obtaining, after the particular virtual break session, user feedback associated with the particular virtual break session, including an user-rating of the particular virtual break session and subsequent interactions by the user with attendees of the particular virtual break session. After providing the notification: receiving user-input indicating a declination of the particular virtual break session; and updating, based on receiving the user-input indicating the declination of the particular virtual break session, the weight for each of the user preferences. Generating a first directed graph between the user and one or more other collaborators based on the collaboration preferences of the user, wherein each collaborator is a vertex of the first directed graph and each of the collaboration preference weights is associated with an edge between the user and the vertices of the first directed graph; and generating a second directed graph between the user and one or more topics based on the topic preferences of the user, wherein each topic is a vertex of the second directed graph and each of the topic preference weights is associated with an edge between the user and the vertices of the second directed graph; wherein generating the score each virtual break session of the plurality of potential virtual break sessions is based on the first directed graph and the second directed graph.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing virtual break sessions.

FIG. 3 illustrates a method for managing virtual break sessions.

FIGS. 4A-4C illustrate graphical user interfaces associated with the virtual break sessions.

FIG. 5 illustrates a notification related to the virtual break session.

FIG. 6 illustrates a graphical user interface depicting a virtual break session.

### DESCRIPTION OF PARTICULAR EMBODIMENT(S)

This disclosure discusses methods and systems for managing virtual break sessions at an information handling system. In short, opportunities are provided for users to be matched according to their interests, given daily time schedule, and meetings and history of interactions, and interest in particular topics. Virtual break sessions can be generated based on such metrics.

Specifically, this disclosure discusses a system and a method for managing virtual break sessions for a user of an information handling system, the method including identifying a plurality of user preferences associated with virtual break sessions, including collaboration preferences, topic preferences, and time preferences; generating a weight for one or more of the user preferences; generating, based on the weights for the user preferences, a score for each virtual break session of a plurality of potential virtual break sessions; comparing the score of each virtual break session of the plurality of potential virtual break sessions to a threshold score; determining, based on the comparing, that the score for a particular virtual break session of the plurality of potential virtual break sessions is greater than the threshold score; in response to determining that the score for the particular virtual break session of the plurality of potential virtual break sessions is greater than the threshold score, providing a notification to a display device of the information handling system indicating the particular virtual break session proximate to a time associated with the particular virtual break session; obtaining, during the particular virtual break session, user engagement signals associated with the particular virtual break session; and updating, based on the user engagement signals, the weight for each of the user preferences.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

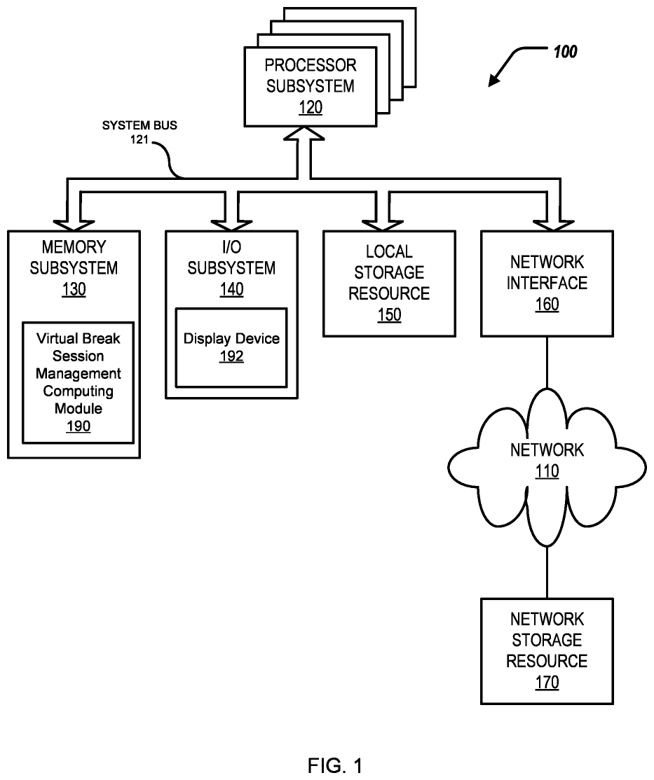

Particular embodiments are best understood by reference to FIGS. 1-6 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, or a camera, or another type of peripheral device. For example, the I/O subsystem 140 can include a display device 192.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g. corporate) network. The network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g. customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a virtual break session management computing module 190. The virtual break session management computing module 190 can be included by the memory subsystem 130. The virtual break session management computing module 190 can include a computer-executable program (software). The virtual break session management computing module 190 can be executed by the processor subsystem 120.

In short, the virtual break session management computing module 190 can facilitate providing opportunities for users to be matched according to their interests, given daily time schedule, and meetings and history of interactions, and interest in particular topics. The virtual break session management computing module 190 can generate virtual break sessions based on such metrics.

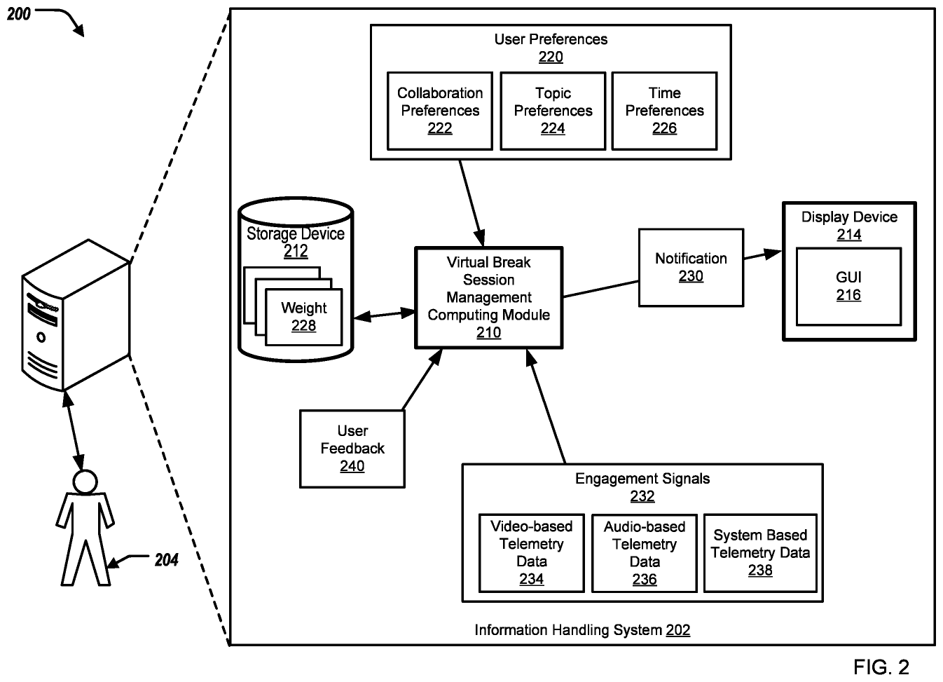

Turning to FIG. 2, FIG. 2 illustrates an environment 200 including an information handling system 202 and a user 204. The information handling system 202 can include a virtual break session management computing module 210, a storage device 212, and a display device 214. In some examples, the information handling system 202 is similar to, or includes, the information handling system 100 of FIG. 1. In some examples, the virtual break session management computing module 210 is the same, or substantially the same, as the virtual break session management computing module 190 of FIG. 1. In some examples, the display device 214 is the same, or substantially the same, as the display device 192 of FIG. 1.

The virtual break session management computing module 210 can be in communication with the storage device 212 and the display device 214.

The display device 214 can present for display a graphical user interface (GUI) 216.

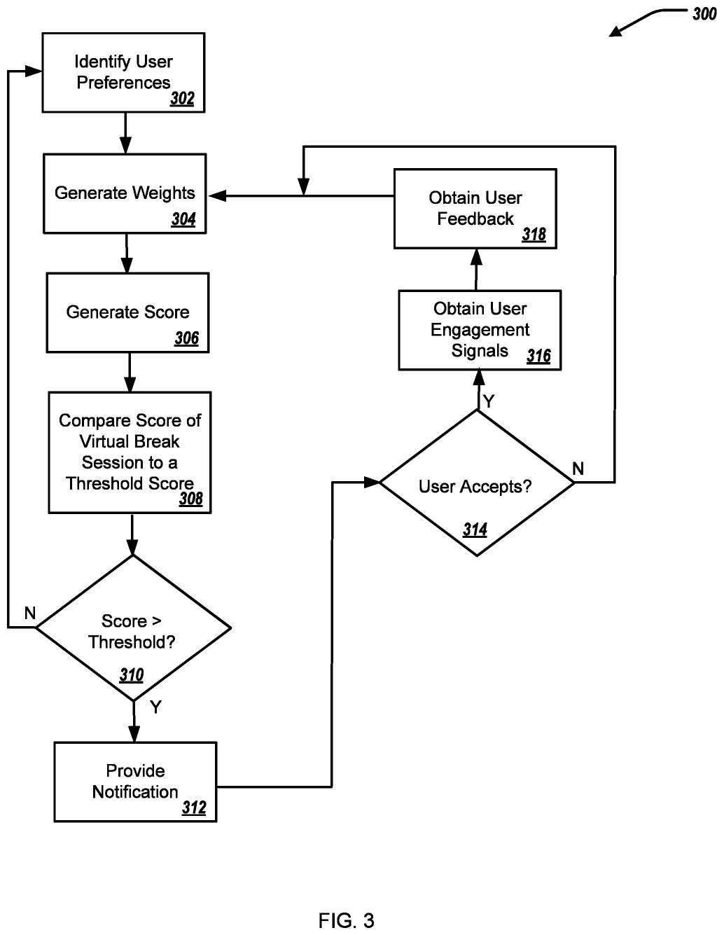

FIG. 3 illustrates a flowchart depicting selected elements of an embodiment of a method 300 for managing virtual break sessions at the information handling system 202. The method 300 may be performed by the information handling system 100, the information handling system 202 and/or the virtual break session management computing module 210, and with reference to FIGS. 1, 2, and 4-6. It is noted that certain operations described in method 300 may be optional or may be rearranged in different embodiments.

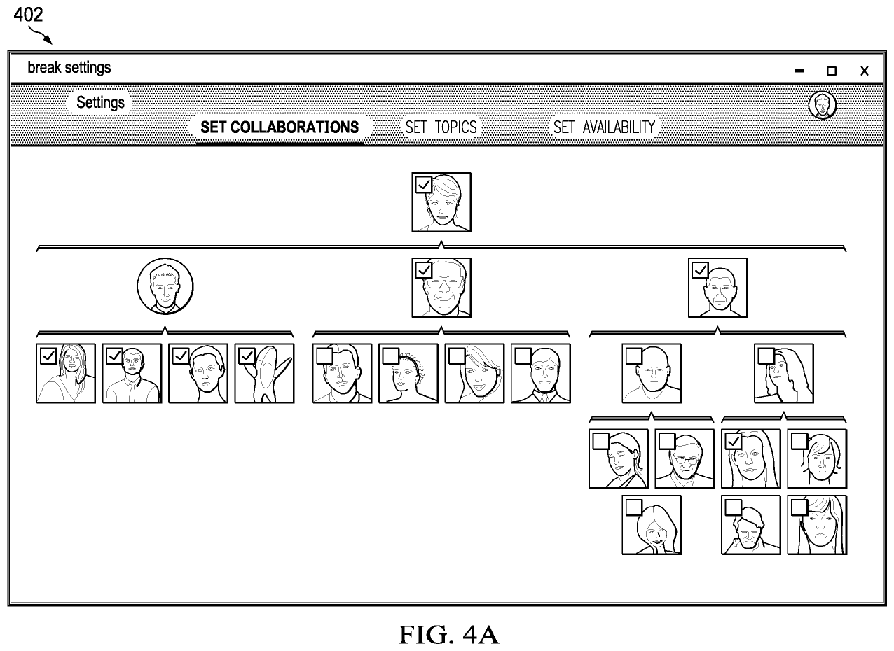

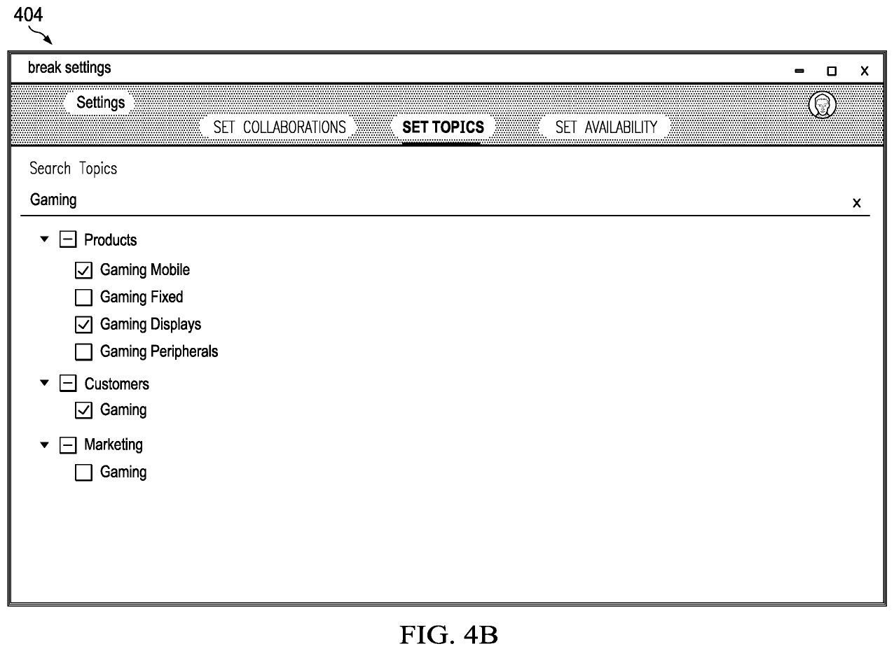

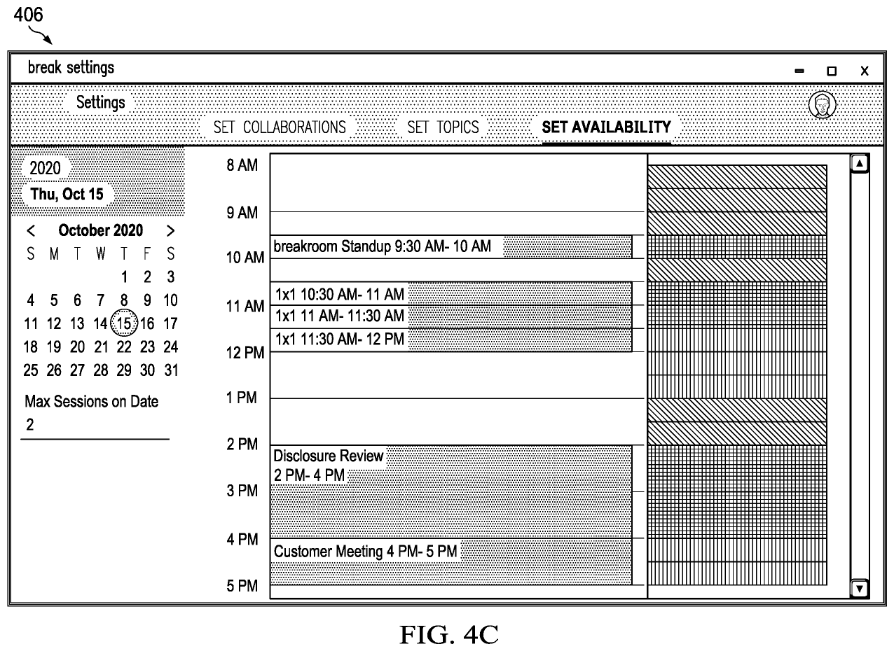

The virtual break session management computing module 210 can identify a plurality of user preferences 220 associated with virtual break sessions, at 302. In some examples, the user preferences 220 can include collaboration preferences 222. FIG. 4A illustrates an example collaboration preference interface 402 for display on the GUI 216 of the display device 214. In particular, the user 204 can interact with the information handling system 202, and in particular, the collaboration preference interface 402, to indicate the collaboration preferences 220. For example, the collaboration preference interface 402 can include an organizational chart within a work environment of the user 204.

In some examples, the user preferences 220 can include topic preferences 224. FIG. 4B illustrates an example topic preference interface 404 for display on the GUI 216 of the display device 214. In particular, the user 204 can interact with the information handling system 202, and in particular, the topic preference interface 404, to indicate the topic preferences 224. For example, the topic preference interface 404 can include a listing of topics associated with the work environment of the user 204.

In some examples, the user preferences 220 can include time preferences 226. FIG. 4C illustrates an example time preference interface 406 for display on the GUI 216 of the display device 214. In particular, the user 204 can interact with the information handling system 202, and in particular, the time preference interface 406, to indicate the time preferences 226. For example, the time preference interface 406 can include a listing of times the user 204 is available.

The virtual break session management computing module 210 can generate respective weights 228 for one or more of the user preferences 220, at 304. The data indicating the weights 228 can be stored at the storage device 212 by the virtual break session management computing module 210. For example, for each collaboration preference for each collaborator, the virtual break session management computing module 210 can generate an associated weight 228. For example, for each topic preference for each topic, the virtual break session management computing module 210 can generate an associated weight 228. For example, for each time preference for each period of time (e.g., 5 minutes, 10 minutes, 15 minutes), the virtual break session management computing module 210 can generate an associated weight 228.

In some examples, the virtual management computing module 210 can generate a first directed graph between the user 204 and one or more other collaborators based on the collaboration preferences 222 of the user 204. Each collaborator is a vertex of the first directed graph and each of the collaboration preference weights 228 is associated with an edge between the user 204 and the vertices of the first directed graph. In some examples, the first directed graph can include a recency penalty for each of the collaborators such that the weights for more recent collaborators during a virtual break session is reduced.

In some examples, the virtual management computing module 210 can generate a second directed graph between the user 204 and one or more topics based on the topic preferences 224 of the user 204. Each topic is a vertex of the second directed graph and each of the topic preference weights 228 is associated with an edge between the user 204 and the vertices of the second directed graph. In some examples, the second directed graph can include a recency penalty for each of the topics such that the weights for more recent topics during a virtual break session is reduced.

The virtual management computing module 210 can generate, based on the weights 228 for the user preferences 220, a score for each virtual break session of a plurality of potential virtual break sessions, at 306. That is, the virtual management computing module 210 can access the weights 228, and for each combination of collaboration preference 222, topic preference 224, and time preference 226, the virtual management computing module 210 can generate the score for the potential virtual break session based on the respective weights. In some examples, the virtual management computing module 210 can generate the score for each virtual break session of the plurality of potential virtual break sessions based on the first directed graph and the second directed graph. That is, the virtual management computing module 210 can generate the score for each virtual break session of the plurality of potential virtual break sessions based on the weights of each edge for each vertex of the respective directed graph.

The virtual management computing module 210 can compare the score of each virtual break session of the plurality of potential virtual break sessions to a threshold score, at 308. The virtual management computing module 210 can determine, based on the comparing, whether the score for a particular virtual break session of the plurality of potential break sessions is greater than the threshold score, at 310.

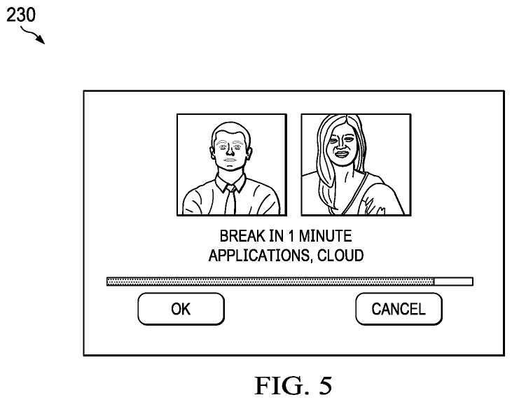

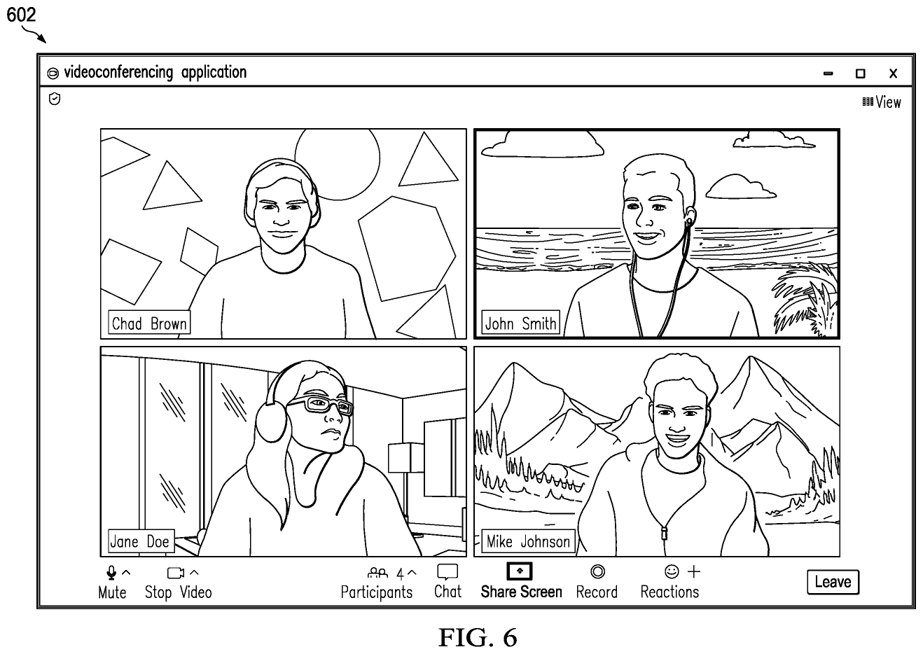

In some examples, the virtual management computing module 210 can determine that the score for the particular virtual break session of the plurality of potential virtual break sessions is greater than the threshold score (at 310), and in response, provide a notification 230 to the display device 214 of the information handling system 202 indicating the particular virtual break session proximate to a time associated with the particular virtual break session, at 312. For example, for a particular virtual break session associated with a time of 2 pm, the virtual management computing module 210 can provide the notification 230 to the display device 214 indicating the particular virtual beak session proximate to the time of 2 pm (e.g., 158 pm). FIG. 5 illustrates an example notification 230 that is displayed on the GUI 216 of the display device 214. FIG. 6 illustrates an example virtual break session 602.

In some examples, the virtual management computing module 210 can determine that the score for each of the virtual break sessions of the plurality of potential virtual break sessions is less than the threshold score (at 310), and in response, return back to step 302.

The virtual management computing module 210 can determine, in response to the notification 230, whether user-input from the user 204 indicates an acceptance of the particular virtual break session or a declination of the particular virtual break session, at 314. In some examples, the virtual management computing module 210 can determine that the user 204 provides user-input indicating an acceptance of the notification 230 and the particular virtual break session (at 314), and in response, obtain, during the particular virtual break session, user engagement signals 232 associated with the particular virtual break session, at 316.

In some examples, the engagement signals 232 can include video-based user telemetry data 234. The virtual management computing module 210 can perform facial analysis of the user 204 during the particular virtual break session to obtain the engagement signals 232. The virtual management computing module 210 can perform facial analysis of the user 204 to obtain the video-based user telemetry data 234, such as facial expressions, gestures, laughter, head position, body position, among others.

In some examples, the engagement signals 232 can include audio-based user telemetry data 236. The virtual management computing module 210 can perform audio analysis of the user 204 during the particular virtual break session to obtain the engagement signals 232. The virtual management computing module 210 can perform audio analysis of the user 204 to obtain the audio-based user telemetry data 234, such as tone analysis, word sentiment, interaction (speaking time, word counts, cadence), among others.

In some examples, the engagement signals 232 can include system based telemetry data 238. The virtual management computing module 210 can perform system interaction analysis of the user 204 during the particular virtual break session to obtain the engagement signals 232. The virtual management computing module 210 can perform system interaction analysis of the user 202 to obtain the system based telemetry data 238, such as user focus (window focus, mouse position, inactivity), user attention (gaze, eye tracking, head position, body posture), session participation (leaving early).

The virtual management computing module 210 can obtain, after the particular virtual break session, user feedback 240 associated with the particular virtual break session, at 318. In some examples, the user feedback 240 can include an user-rating of the particular virtual break session. For example, the user feedback 240 can include survey responses. In some examples, the user feedback 240 can include data indicating subsequent interactions by the user 204 with attendees of the particular virtual break session. For example, the user feedback 240 can include post-session communication activities (emails, chats, follow-up meetings).

The virtual management computing module 210 can update, based on the engagement signals 232, the weights 228 for each of the user preferences 220, at 304. For example, when the engagement signals 232 indicate a positive correlation, the weights 228 for the user preferences 220 associated with the particular virtual break session are increased. For example, when the engagement signals 232 indicate a negative correlation, the weights 228 for the user preferences 220 associated with the particular virtual break session are decreased.

In some examples, the virtual management computing module 210 can determine that the user 204 provides user-input indicating a declination of the notification 230 and the particular virtual break session (at 314), and in response, update, based on the user-input indicating the declination of the particular virtual break session, the weights 228 for each of the user preferences 220, at 304. For example, the weights 228 for the user preferences 220 associated with the particular virtual break session are decreased.

In some examples, after updating the weights 228, at 304, the virtual management computing module 210 can generate, based on the updated weights 228 for the user preferences 220, an updated score for each virtual break sessions of the plurality of potential virtual break sessions, at 306. The virtual management computing module 210 can compare the updated score of each virtual break session of the plurality of potential virtual break sessions to the threshold score, at 308. The virtual management computing module 210 can determine, based on the comparing, whether the updated score for a further virtual break session of the plurality of potential break sessions is greater than the threshold score, at 310. The virtual management computing module 210 can determine that the updated score for the further virtual break session of the plurality of potential virtual break sessions is greater than the threshold score (at 310), and in response, provide a further notification 230 to the display device 214 of the information handling system 202 indicating the further virtual break session proximate to a further time associated with the further virtual break session, at 312. The virtual management computing module 210 can obtain, during the further virtual break session, further user engagement signals 232 associated with the further virtual break session, at 316. The virtual management computing module 210 can update, based on the further engagement signals 232, the updated weights 228 for each of the user preferences 220, at 304.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated other-wise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A computer-implemented method of managing virtual break sessions for a user of an information handling system, the method comprising:
identifying a plurality of user preferences associated with virtual break sessions, including collaboration preferences, topic preferences, and time preferences;
generating a weight for one or more of the user preferences;
generating, based on the weights for the user preferences, a score for each virtual break session of a plurality of potential virtual break sessions;
comparing the score of each virtual break session of the plurality of potential virtual break sessions to a threshold score;
determining, based on the comparing, that the score for a particular virtual break session of the plurality of potential virtual break sessions is greater than the threshold score;
in response to determining that the score for the particular virtual break session of the plurality of potential virtual break sessions is greater than the threshold score, providing a notification to a display device of the information handling system indicating the particular virtual break session proximate to a time associated with the particular virtual break session;
obtaining, during the particular virtual break session, user engagement signals associated with the particular virtual break session; and
updating, based on the user engagement signals, the weight for each of the user preferences.

2. The computer-implemented method of claim 1, further comprising after updating the weight for each of the user preferences:
generating, based on the updated weights for each of the user preferences, an updated score for each virtual break session of the plurality of potential virtual break sessions;
comparing the updated score of each virtual break session of the plurality of potential virtual break sessions to the threshold score;
determining, based on the comparing, that the updated score for a further virtual break session of the plurality of potential virtual break sessions is greater than the threshold score;
in response to determining that the updated score for the further virtual break session of the plurality of potential virtual break sessions is greater than the threshold score, providing a further notification to the display device of the information handling system indicating the further virtual break session proximate to a further time associated with the further virtual break session;
obtaining, during the further virtual break session, further user engagement signals associated with the further virtual break session; and
updating, based on the further user engagement signals, the updated weight for each of the user preferences.

3. The computer-implemented method of claim 1, wherein obtaining the user engagement signals includes obtaining video-based user telemetry data, including performing facial analysis of the user during the particular virtual break session.

4. The computer-implemented method of claim 1, wherein obtaining the user engagement signals includes obtaining audio-based user telemetry data, including performing audio analysis of the user during the particular virtual break session.

5. The computer-implemented method of claim 1, wherein obtaining the user engagement signals includes obtaining system based telemetry data, including performing system interaction analysis of the user during the particular virtual break session.

6. The computer-implemented method of claim 1, further comprising:
obtaining, after the particular virtual break session, user feedback associated with the particular virtual break session, including an user-rating of the particular virtual break session and subsequent interactions by the user with attendees of the particular virtual break session.

7. The computer-implemented method of claim 1, further comprising after providing the notification:
receiving user-input indicating a declination of the particular virtual break session; and
updating, based on receiving the user-input indicating the declination of the particular virtual break session, the weight for each of the user preferences.

8. The computer-implemented method of claim 1, further comprising:
generating a first directed graph between the user and one or more other collaborators based on the collaboration preferences of the user, wherein each collaborator is a vertex of the first directed graph and each of the collaboration preference weights is associated with an edge between the user and the vertices of the first directed graph; and
generating a second directed graph between the user and one or more topics based on the topic preferences of the user, wherein each topic is a vertex of the second directed graph and each of the topic preference weights is associated with an edge between the user and the vertices of the second directed graph;
wherein generating the score each virtual break session of the plurality of potential virtual break sessions is based on the first directed graph and the second directed graph.

9. An information handling system comprising a processor having access to memory media storing instructions executable by the processor to perform operations, comprising:
identifying a plurality of user preferences associated with virtual break sessions, including collaboration preferences, topic preferences, and time preferences;
generating a weight for one or more of the user preferences;
generating, based on the weights for the user preferences, a score for each virtual break session of a plurality of potential virtual break sessions;
comparing the score of each virtual break session of the plurality of potential virtual break sessions to a threshold score;
determining, based on the comparing, that the score for a particular virtual break session of the plurality of potential virtual break sessions is greater than the threshold score;
in response to determining that the score for the particular virtual break session of the plurality of potential virtual break sessions is greater than the threshold score, providing a notification to a display device of the information handling system indicating the particular virtual break session proximate to a time associated with the particular virtual break session;
obtaining, during the particular virtual break session, user engagement signals associated with the particular virtual break session; and
updating, based on the user engagement signals, the weight for each of the user preferences.

10. The information handling system of claim 9, the operations further comprising after updating the weight for each of the user preferences:
generating, based on the updated weights for each of the user preferences, an updated score for each virtual break session of the plurality of potential virtual break sessions;
comparing the updated score of each virtual break session of the plurality of potential virtual break sessions to the threshold score;
determining, based on the comparing, that the updated score for a further virtual break session of the plurality of potential virtual break sessions is greater than the threshold score;
in response to determining that the updated score for the further virtual break session of the plurality of potential virtual break sessions is greater than the threshold score, providing a further notification to the display device of the information handling system indicating the further virtual break session proximate to a further time associated with the further virtual break session;
obtaining, during the further virtual break session, further user engagement signals associated with the further virtual break session; and
updating, based on the further user engagement signals, the updated weight for each of the user preferences.

11. The information handling system of claim 9, wherein obtaining the user engagement signals includes obtaining video-based user telemetry data, including performing facial analysis of the user during the particular virtual break session.

12. The information handling system of claim 9, wherein obtaining the user engagement signals includes obtaining audio-based user telemetry data, including performing audio analysis of the user during the particular virtual break session.

13. The information handling system of claim 9, wherein obtaining the user engagement signals includes obtaining system based telemetry data, including performing system interaction analysis of the user during the particular virtual break session.

14. The information handling system of claim 9, the operations further comprising:
obtaining, after the particular virtual break session, user feedback associated with the particular virtual break session, including an user-rating of the particular virtual break session and subsequent interactions by the user with attendees of the particular virtual break session.

15. The information handling system of claim 9, the operations further comprising after providing the notification:
receiving user-input indicating a declination of the particular virtual break session; and
updating, based on receiving the user-input indicating the declination of the particular virtual break session, the weight for each of the user preferences.

16. The information handling system of claim 9, the operations further comprising:
generating a first directed graph between the user and one or more other collaborators based on the collaboration preferences of the user, wherein each collaborator is a vertex of the first directed graph and each of the collaboration preference weights is associated with an edge between the user and the vertices of the first directed graph; and
generating a second directed graph between the user and one or more topics based on the topic preferences of the user, wherein each topic is a vertex of the second directed graph and each of the topic preference weights is associated with an edge between the user and the vertices of the second directed graph;
wherein generating the score each virtual break session of the plurality of potential virtual break sessions is based on the first directed graph and the second directed graph.

17. A non-transitory computer-readable medium storing software comprising instructions executable by one or more computers which, upon such execution, cause the one or more computers to perform operations comprising:
identifying a plurality of user preferences associated with virtual break sessions, including collaboration preferences, topic preferences, and time preferences;
generating a weight for one or more of the user preferences;
generating, based on the weights for the user preferences, a score for each virtual break session of a plurality of potential virtual break sessions;
comparing the score of each virtual break session of the plurality of potential virtual break sessions to a threshold score;
determining, based on the comparing, that the score for a particular virtual break session of the plurality of potential virtual break sessions is greater than the threshold score;
in response to determining that the score for the particular virtual break session of the plurality of potential virtual break sessions is greater than the threshold score, providing a notification to a display device of the information handling system indicating the particular virtual break session proximate to a time associated with the particular virtual break session;
obtaining, during the particular virtual break session, user engagement signals associated with the particular virtual break session; and
updating, based on the user engagement signals, the weight for each of the user preferences.

18. The computer-readable medium of claim 17, the operations further comprising after updating the weight for each of the user preferences:
generating, based on the updated weights for each of the user preferences, an updated score for each virtual break session of the plurality of potential virtual break sessions;
comparing the updated score of each virtual break session of the plurality of potential virtual break sessions to the threshold score;
determining, based on the comparing, that the updated score for a further virtual break session of the plurality of potential virtual break sessions is greater than the threshold score;
in response to determining that the updated score for the further virtual break session of the plurality of potential virtual break sessions is greater than the threshold score, providing a further notification to the display device of the information handling system indicating the further virtual break session proximate to a further time associated with the further virtual break session;
obtaining, during the further virtual break session, further user engagement signals associated with the further virtual break session; and
updating, based on the further user engagement signals, the updated weight for each of the user preferences.

19. The computer-readable medium of claim 17, wherein obtaining the user engagement signals includes obtaining video-based user telemetry data, including performing facial analysis of the user during the particular virtual break session.

20. The computer-readable medium of claim 17, wherein obtaining the user engagement signals includes obtaining audio-based user telemetry data, including performing audio analysis of the user during the particular virtual break session.
